(19) United States
(12) Patent Application Publication
(10) Pub. No.: US 2006/0024126 A1
(43) Pub. Date: Feb. 2, 2006

(54) Page lifting spring

(76) Inventors: Kenneth Lester Johansson, North Grafton, MA (US); John Louis Brady, Worcester, MA (US)

Correspondence Address: Kenneth Lester Johansson, 114 Old Westboro Road, North Grafton, MA, 01536, US

(21) Appl. No.: 11/194,312

(22) Filed: Aug. 1, 2005

Related U.S. Application Data
(60) Provisional application No. 60/592,587, filed on Jul. 31, 2004.

(51) Int. Cl. B42F 13/00

(52) U.S. Cl. 402/79

(57) ABSTRACT

Described is an improvement to a loose-leaf binder, also known as a loose-leaf notebook, to facilitate moving the covers and pages from an open position to a closed position without the intervention of special closing techniques. With the system created with this invention, the binder covers are simply closed.

### FIELD OF INVENTION

The invention relates generally to loose-leaf binders, which are also called loose-leaf notebooks.

### BACKGROUND

Loose-leaf binders, also known as loose-leaf notebooks is a system for storing pages which have holes on one edge, on rings which retain the pages between two protective covers. The binders consist of a front and back cover each attached to an edge of the binder center section. A set of rings that can open or close are attached to a spine that is in turn attached to the inside center section of the binder. The rings are hinged in the spine section and have two stable positions that are either open or closed. The pages which have holes punched along one edge are placed over the open rings. When all the pages are placed on the rings, the rings are closed which keeps the pages on the rings and in the binder. The two covers are then folded together with the pages positioned between them.

The larger loose-leaf binders that have rings typically two inches or greater in diameter, have a long history of being difficult to close. Special closing techniques have been required so that the pages closest to each cover do not get trapped. When the pages do get trapped between the rings and the covers, the holes in the pages tend to rip and the pages make a permanent curl in the ring area.

A summary of the problems associated with large loose-leaf binders is: They are difficult to close. They require special closing techniques, such as manually centering the pages prior to closing the binder. The pages are damaged if the binder is forced closed. Lastly the pages that get trapped between the covers and the rings become permanently curled thus exacerbating the problem.

It was the lack of finding a simple solution to this very aggravating problem that caused the authors of this invention to develop it.

### SUMMARY OF INVENTION

Large loose-leaf binders are typically supplied with two page lifters of prior art. These page lifters typically are curved or flat pieces of rigid material that are placed on the binder rings next to the covers. The notebook pages are then placed on the rings and then the rings are closed. When the binder begins to close, the page lifter, as its name implies, is supposed to lift the notebook pages on the rings such that the pages can continue to ride up the rings as needed, until the binder is fully closed. When a loose-leaf binder is fully closed, all of the pages should be located on the top half of the rings furthest away from the location where the rings are hinged.

The page lifters of prior art commonly supplied with the loose-leaf binders do not work well. They typically will not lift the pages without some type of assistance. The page lifters as supplied do present a durable surface to manually lift upon when closing a large binder. However, as stand alone devices, which will automatically lift the pages as the binder is closed, these page lifters at best work very poorly and more likely do not work at all.

The subject of this invention is called the Page Lifting Spring. The Page Lifting Spring works in combination with the page lifters of prior art to form a unique Page Lifting System. This system truly lifts the pages of a loose-leaf binder automatically on the rings as the binder is moved from the open to the closed position. The Page Lifting Spring is a one-sheet piece of somewhat stiff durable material that spans part of, or all of, both covers, as well as the center section of a loose-leaf binder. The sheet has slots, which accommodate the binder rings (see FIG. 2). With the binder open and on a flat surface the Page Lifting Spring is installed on the binder rings first. The page lifters of prior art are installed next and then the pages. When the binder is closed, the Page Lifting Spring causes the page lifters of prior art to ride up the binder rings as the binder covers are folded to a closed position, therefore, lifting the pages toward the top position of the binder rings. This Page Lifting System eliminates the problems listed in the background.

### BRIEF DESCRIPTION OF THE DRAWINGS

The above and further advantages of this invention may be better understood by referring to the following description in conjunction with the accompanying drawings, in which the numerals indicate the structural elements and features in various figures. The drawings are not necessarily to scale, emphasis instead being placed upon illustrating the principles of the invention.

FIG. 1 is a drawing of a large three ring loose-leaf binder that is commercially available.

FIG. 2 is a drawing of several types of page lifters of prior art. One set of one of these types of these page lifters is typically supplied with a new binder.

FIG. 3 is a dimensional drawing of a Page Lifting Spring.

FIG. 4 is a drawing showing that the Page Lifting Spring is installed on the binder rings first, then the page lifters of prior art are installed next.

FIG. 5 shows the right and left stacks of notebook pages that are installed on the rings of FIG. 4 after the page lifters of prior art have been installed.

FIG. 6 is an end view that shows how in the absence of a Page Lifting Spring, how the page lifter of prior art can get trapped at the edges of the spine cover of a loose-leaf binder.

### DETAILED DESCRIPTION

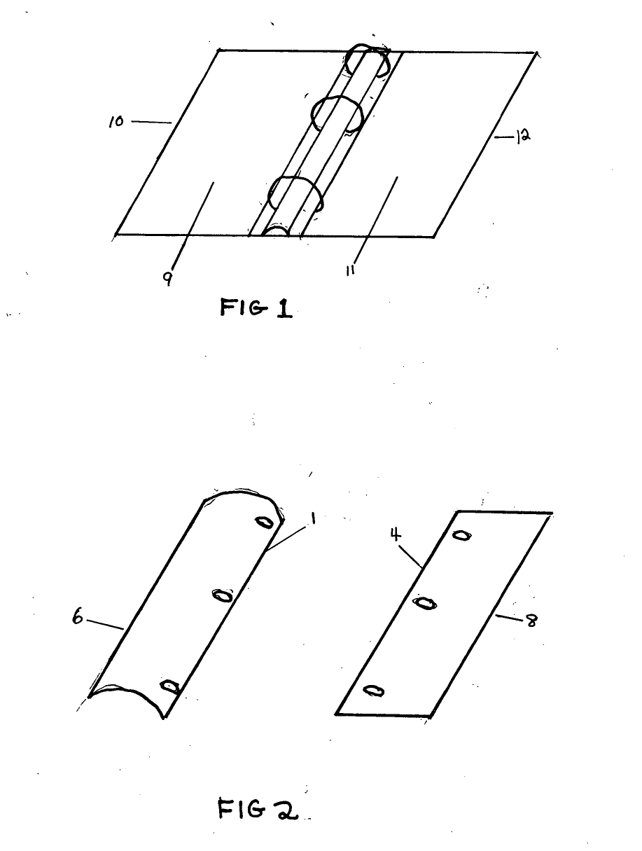

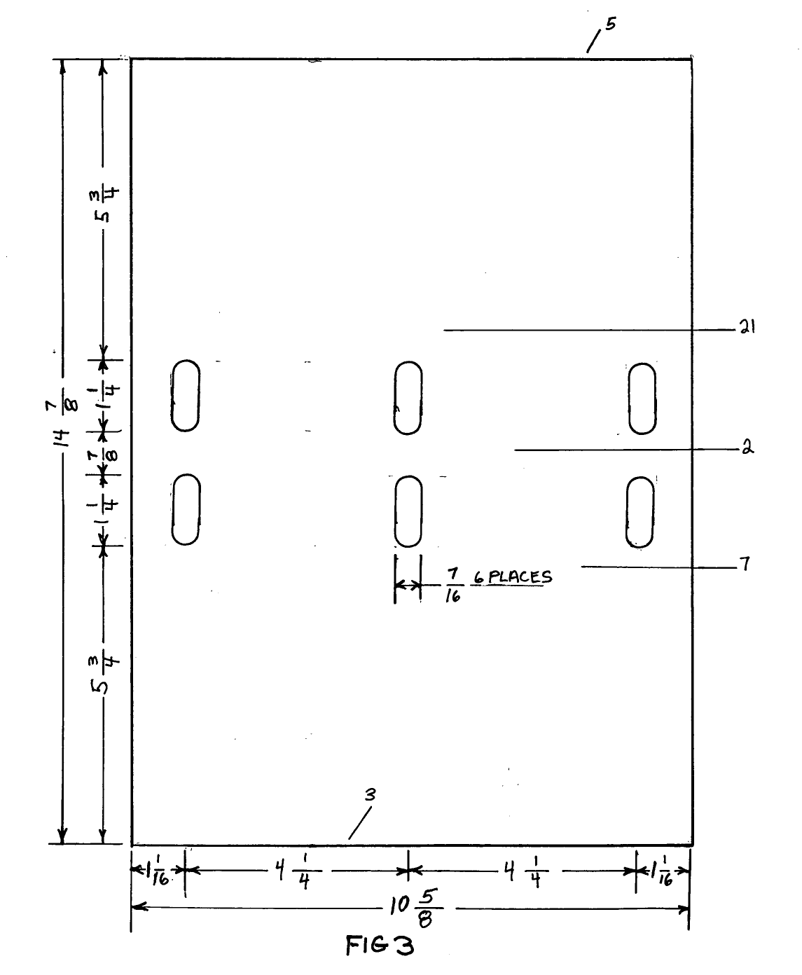

The Page Lifting Spring of FIG. 3 is not a stand-alone device. It must be used in combination with the page lifters of prior art as described in FIG. 2. Together the Page Lifting Spring and the page lifter form a Page Lifting System. The Page Lifting System essentially eliminates the loose-leaf binder closing problems.

The Page Lifting Spring is made of a sheet of relatively stiff durable material such as, but not limited to, plastic or polymer. The typical durometer of this material is 69B.

The Page Lifting Spring is a single sheet of material that spans both covers and the center section of a loose-leaf binder.

The Page Lifting Spring may cover part of each loose-leaf binder cover or it may cover each cover completely.

The Page Lifting Spring has slots created in it so that it can be installed over the loose-leaf binder rings. There are two slots for each binder ring. The Page Lifting Spring slots are sized and located such that the center section of the Page Lifting Spring is flat when the binder is open, and each cover and the center section, is lying on a flat surface such as a table.

The Page Lifting Spring is not attached to the binder center section of the binder or the binder covers, but is kept in place by its slots sliding on the binder rings.

The Page Lifting Spring is first installed on the loose-leaf binder rings. The page lifters of prior art are installed next on the binder rings. The loose-leaf pages are then installed on the rings and then the rings are closed.

As the binder begins to close, several simultaneous actions begin to take place.

Region 1 of FIG. 2 begins to slide toward the outside edges of region 3 of FIG. 3 and simultaneously region 4 of FIG. 2 begins to slide toward the edge of region 5 of FIG. 3. Regions 1 and 4 of FIG. 2 are in contact with region 2 of FIG. 3.

Also as the binder begins to close, region 6 of FIG. 2 begins to slide on region 7 toward region 3 of FIG. 3. Simultaneously region 8 of FIG. 2 begins to slide on region 21 toward region 5 of FIG. 3.

Also as the binder begins to close, region 3 of FIG. 3 begins to slide on region 9 toward region 10 of FIG. 1. Simultaneously region 5 of FIG. 3 begins to slide on region 11 toward region 12 of FIG. 1.

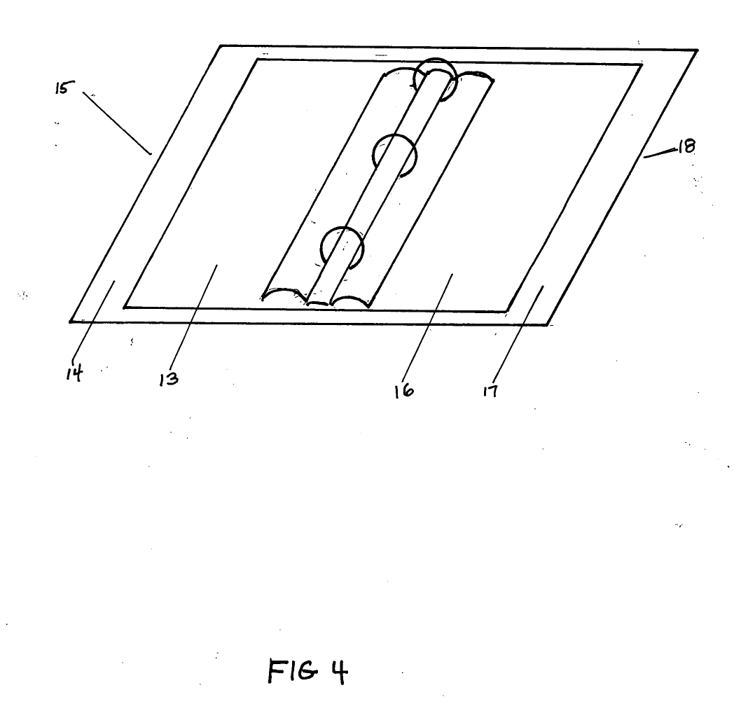

Also as the binder begins to close, the left stack of pages, see FIG. 5, begins to slide on region 13 of the Page Lifting Spring and region 14 which is the left binder cover toward region 15 which is the left edge of the binder cover of FIG. 4. Simultaneously the right stack of pages of FIG. 5 begins to slide on region 16 of the Page Lifting Spring and region 17, which is the right binder cover toward region 18, which is the right edge of the binder cover of FIG. 4.

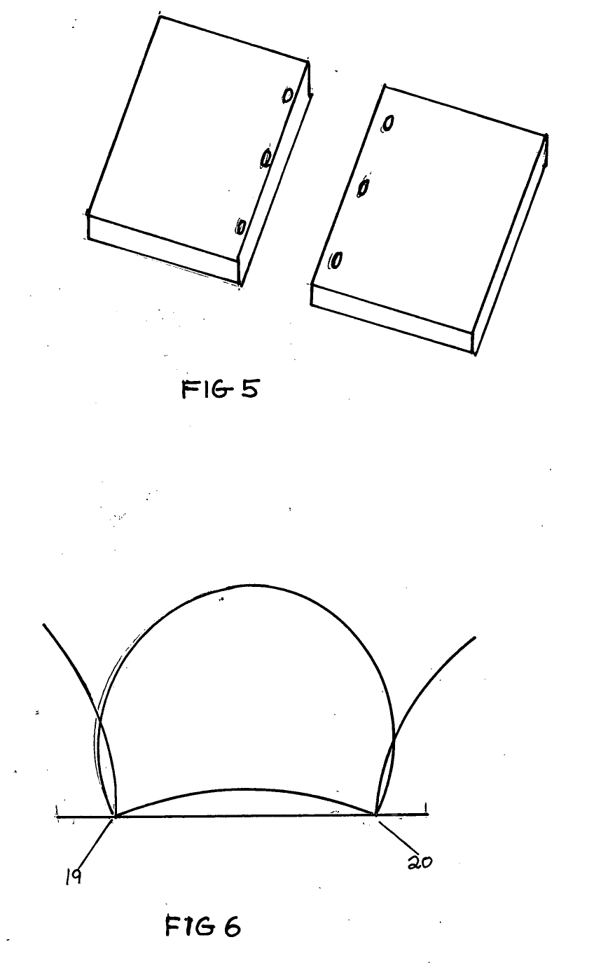

A significant feature of the Page Lifting System is that the Page Lifting Spring will not allow the edges of the page lifters of prior art, regions 1 and 4 of FIG. 2 to fall into the position shown in regions 19 and 20 of FIG. 6. When the Page Lifting Spring is not used the page lifter of prior art can assume the position shown in FIG. 6. When the page lifter is not used with the Page Lifting Spring, there is no lifting action on regions 1 and 4 of FIG. 2. All of the lifting action comes from the page lifters of prior art riding up the ring. When the Page Lifting System is used, the lifting action occurs at the regions 1 and 4 of FIG. 2 as well as the lifting action provided by the rings in the slots of the page lifter of prior art.

What is claimed is:

1. The Page Lifting Spring is a single sheet of material that spans both covers and the center section of a loose-leaf binder.

2. The Page Lifting Spring of claim 1 is not a stand alone device, but works in combination with page lifting devices of prior art to enable large loose-leaf binders to be closed easily without trapping and/or damaging the pages in the binder.

3. The Page Lifting Spring of claim 1 is made of a sheet of relatively stiff durable material such as, but not limited to, plastic or polymer. The typical durometer of this material is 69B.

4. The Page Lifting Spring of claim 1 may cover part of each loose-leaf binder cover or it may cover completely each cover.

5. The Page Lifting Spring of claim 1 has slots created in it so that it can be installed over the loose-leaf binder rings.

6. The Page Lifting Spring of claim 1 will accommodate loose-leaf binders, which have two or more circular rings. A set of two slots is required in the correct location of the Page Lifting Spring for each binder ring. The Page Lifting Spring is used with all of the rings of a loose-leaf binder.

7. The Page Lifting Spring of claim 1, slots, are sized and located such that the center section of the Page Lifting Spring is flat when the binder is open, and each cover and the center section, is lying on a flat surface such as a table.

8. The Page Lifting Spring of claim 1 is not attached to the binder center section or the binder covers, but is kept in place by its slots sliding on the binder rings.

9. The Page Lifting Spring of claim 1 will accommodate loose-leaf binder rings that are circular in nature.

10. The Page Lifting Spring of claim 1 will accommodate shapes of rings other than circular as long as the shape of the ring does not depart too drastically from that of circular rings.

11. The Page Lifting Spring of claim 1 is first installed on the loose-leaf binder rings. The page lifters are installed next on the binder rings. The loose-leaf pages are then installed on the rings and then the rings are closed.

12. The Page Lifting Spring of claim 1, when combined with the page lifter of prior art, to form the Page Lifting System, translates the closing motion of the binder cover to forces which lift the binder pages on the rings of the binder.

13. The Page Lifting Spring of claim 1 may or may not have creases located above the folds of the binder covers. The creases serve to prevent the covers of the binders from springing open once they have been closed. This applies especially to the smaller thickness binders. The binder closes successfully with or without creases in the Page Lifting Spring.

14. The Page Lifting Spring of claim 1 will accommodate several thickness loose-leaf binders. Ideal performance is achieved by using a Page Lifting Spring designed for each particular thickness loose-leaf binder. However a Page Lifting Spring designed for a 3 inch binder will work very well in a 2 inch binder that is an example of how Page Lifting Springs designed for one thickness binder may be successfully used in a binder of a different thickness.

15. The invention of the Page Lifting Spring of claim 1 is intended to include other possible embodiments of the Page Lifting Spring which are held in place by the binder rings within the above listed claims, and is not limited to particular embodiments of the descriptions and figures.
